(19) United States
(12) Patent Application Publication
(10) Pub. No.: US 2024/0413489 A1
(43) Pub. Date: Dec. 12, 2024

(54) INTER-ELECTRODE-TERMINAL CONNECTION COMPONENT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuhei YAMADA, Osaka (JP); Nobuyuki MATSUMURA, Osaka (JP); Masaya TANAKA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/726,292

(22) PCT Filed: Jan. 6, 2023
(86) PCT No.: PCT/JP2023/000121

§ 371 Date: Jul. 2, 2024

(30) Foreign Application Priority Data
Jan. 20, 2022 (JP) 2022-007425

(51) Int. Cl. H01M 50/503; H01M 50/522; H01M 50/526; H01R 11/01

(52) U.S. Cl. CPC H01M 50/503; H01M 50/522; H01M 50/526; H01R 11/01; H01R 2201/26

(57) ABSTRACT

An inter-electrode-terminal connection component is capable of improving stability of connection to electrode terminals while flexibly absorbing locational shifting or displacement of the electrode terminals. An inter-electrode-terminal connection component includes a plurality of electrode connection portions that are to be respectively connected to a plurality of electrode terminals adjacent to each other, and an intermediate conductive portion that is disposed between the electrode connection portions adjacent to each other and in which the electrode connection portions are coupled to the two ends. The electrode connection portions are each constituted by a single flat metal plate. The intermediate conductive portion is constituted by a laminated busbar formed by stacking a plurality of metal thin plates that are thinner than the flat metal plate, and includes an elastically deformable portion that is elastically deformed and thus accepts displacement caused by the electrode connection portions approaching each other or separating from each other.

### TECHNICAL FIELD

The present disclosure relates to an inter-electrode-terminal connection component.

### BACKGROUND ART

Conventionally, inter-electrode-terminal connection components that include a busbar and the like for electrically and physically connect electrode terminals of adjacent devices such as adjacent battery cells and a motor and an inverter adjacent to each other are employed in vehicles such as electric vehicles and hybrid vehicles. The inter-electrode-terminal connection components are required to have flexibility that enables absorption of locational shifting of the installation positions of the electrode terminals or displacement of the electrode terminals after installation. In addition, an increase in volumes of the inter-electrode-terminal connection components is demanded because an amount of heat radiated during electric current application is increased due to adaptation to a larger electric current and higher voltage achieved in recent years. For example, Patent Document 1 proposes that a laminated busbar is used for an inter-electrode-terminal connection component to meet the demand for an increase in volume.

### CITATION LIST

### Patent Document

Patent Document 1: JP 2021-26946A

### SUMMARY OF INVENTION

### Technical Problem

However, with the structure disclosed in Patent Document 1, the entire inter-electrode-terminal connection component is constituted by the laminated busbar, and thus respective portions to be connected to adjacent electrode terminals are included in the laminated busbar and are also flexible. As a result, a gap is generated between the inter-electrode-terminal connection component and the electrode terminal, which leads to a rise in continuity resistance, and thus it is difficult to ensure connection stability, which is an inherent problem.

Therefore, this specification discloses an inter-electrode-terminal connection component that is capable of improving stability of connection to electrode terminals while flexibly absorbing locational shifting or displacement of the electrode terminals.

### Solution to Problem

An inter-electrode-terminal connection component of the present disclosure includes: a plurality of electrode connection portions that are to be respectively connected to a plurality of electrode terminals adjacent to one another; and an intermediate conductive portion that is disposed between the electrode connection portions adjacent to each other and in which the electrode connection portions are coupled to two ends, wherein the electrode connection portions are each constituted by a single flat metal plate, and the intermediate conductive portion is constituted by a laminated busbar formed by stacking a plurality of metal thin plates that are thinner than the flat metal plate, and includes an elastically deformable portion that is elastically deformed and thus accepts displacement of the electrode connection portions approaching each other or separating from each other.

### BRIEF DESCRIPTION OF DRAWINGS

FIG. 1 is a perspective view showing an inter-electrode-terminal connection component according to Embodiment 1.

FIG. 2 is a perspective view showing a state in which the inter-electrode-terminal connection components shown in FIG. 1 are connected to a plurality of battery cells.

FIG. 3 is a perspective view showing an inter-electrode-terminal connection component according to Embodiment 2.

FIG. 4 is a perspective view showing an inter-electrode-terminal connection component according to Embodiment 3.

FIG. 5 is an explanatory diagram for illustrating a specific example of a method for manufacturing the inter-electrode-terminal connection component shown in FIG. 4.

FIG. 6 is a perspective view showing an inter-electrode-terminal connection component according to a modified example of Embodiment 3.

FIG. 7 is a perspective view showing an inter-electrode-terminal connection component according to Embodiment 4.

FIG. 8 is a perspective view showing an inter-electrode-terminal connection component according to Embodiment 5.

FIG. 9 is a perspective view showing an inter-electrode-terminal connection component according to Embodiment 6.

FIG. 10 is a perspective view showing an inter-electrode-terminal connection component according to another aspect.

### DESCRIPTION OF EMBODIMENTS

### Description of Embodiments of the Present Disclosure

First, aspects of the present disclosure will be listed and described.
(1) An inter-electrode-terminal connection component of the present disclosure includes: a plurality of electrode connection portions that are to be respectively connected to a plurality of electrode terminals adjacent to one another; and an intermediate conductive portion that is disposed between the electrode connection portions adjacent to each other and in which the electrode connection portions are coupled to two ends, wherein the electrode connection portions are each constituted by a single flat metal plate, and the intermediate conductive portion is constituted by a laminated busbar formed by stacking a plurality of metal thin plates that are thinner than the flat metal plate, and includes an elastically deformable portion that is elastically deformed and thus accepts displacement of the electrode connection portions approaching each other or separating from each other.

With the inter-electrode-terminal connection component of this aspect, the adjacent electrode connection portions to be respectively connected to adjacent electrode terminals are coupled via an intermediate conductive portion, and each of the electrode connection portions is constituted by a single flat metal plate. This reduces the risk of generation of a gap between the electrode connection portion and the electrode terminal compared to the conventional structure in which portions of a laminated busbar form the electrode connection portions, thus making it possible to provide an inter-electrode-terminal connection component with improved stability of connection to the electrode terminals.

In addition, the intermediate conductive portion in which the electrode connection portions are coupled to the two ends is constituted by the laminated busbar formed by stacking a plurality of metal thin plates that are thinner than the flat metal plates forming the electrode connection portions. Accordingly, when external force is applied in a direction in which the electrode connection portions approach each other or separate from each other, the intermediate conductive portion is elastically deformed more easily compared to an intermediate conductive portion that is constituted by a busbar formed using a single metal plate with the same cross-sectional area. As a result, the displacement of the electrode connection portions approaching each other or separating from each other can be accepted with excellent following ability, and the structure of the elastically deformable portion can be simplified without an increase in size. Accordingly, the elastically deformable portion can flexibly absorb the locational shifting of the electrode terminals during connection operation where the electrode terminals are connected to each other via the inter-electrode-terminal connection component, or the displacement of the electrode terminals after the connection.

Note that any of methods for coupling the two ends of the intermediate conductive portion to the pair of electrode connection portions can be employed as long as electrical and physical connection of the intermediate conductive portion to the electrode connection portions can be realized. For example, welding such as ultrasonic welding or laser welding, or fastening using fastening components may be used.

The inter-electrode-terminal connection component of this aspect can be used to connect any adjacent electrode terminals. For example, the inter-electrode-terminal connection component can be used to connect adjacent electrode terminals in a plurality of battery cells of a battery pack and connect adjacent electrode terminals of devices (e.g., a motor, an inverter, and the like) adjacent to each other.

Furthermore, it is sufficient that the inter-electrode-terminal connection component of this aspect has at least a pair of electrode connection portions and an intermediate conductive portion via which the electrode connection portions are coupled, in order to connect adjacent electrode terminals, but also encompasses those having two or more intermediate conductive portions in which electrode connection portions are coupled to the two ends in order to connect adjacent three or more electrode terminals. An inter-electrode-terminal connection component in which a pair of electrode connection portions is coupled via a single intermediate conductive portion can be used to physically and electrically connect a positive electrode terminal and a negative electrode terminal that are adjacent to each other when, for example, a plurality of battery cells are connected in series. An inter-electrode-terminal connection component in which three or more electrode connection portions disposed with intervals are coupled via two or more intermediate conductive portions disposed between the electrode connection portions can be used to physically and electrically connect three or more positive electrode terminals or negative electrode terminals that are adjacent to one another when three or more battery cells are connected in parallel.
(2) It is preferable that the intermediate conductive portion includes plate-shaped coupling portions at the two ends and the elastically deformable portion is constituted by a portion between the coupling portions, and the electrode connection portions each include a plate-shaped coupling-target portion that is overlaid on and coupled to the coupling portion of the intermediate conductive portion, and a plate-shaped connection portion that is to be overlaid on and connected to the electrode terminal. Since the plate-shaped coupling portions provided at the two ends of the intermediate conductive portion are each overlaid on and coupled to the plate-shaped coupling-target portion of the electrode connection portion, the area of contact between the intermediate conductive portion and the electrode connection portion is advantageously secured, so that the intermediate conductive portion and the electrode connection portions are easily connected through welding or the like, and stable conductive connection between the intermediate conductive portion and the electrode connection portions is realized. In addition, in the intermediate conductive portion, the elastically deformable portion is constituted by a portion between the coup ling portions located at the two ends. Therefore, there is no restriction by the electrode connection portions, a region that is elastically deformed due to external force applied in a direction in which the electrode connection portions approach each other or separate from each other can be secured in a broader range, and the ability of the elastically deformable portion to follow the locational shifting of the electrode terminals and the flexibility thereof can be advantageously secured.
(3) It is preferable that the coupling-target portions of the electrode connection portions each protrude toward an upper side that is farther from the electrode terminal than the connection portion is. The coupling-target portions of the electrode connection portions each protrude toward the upper side that is farther from the electrode terminal than the connection portion to be overlaid on the electrode terminal is, and therefore, even when the surface of the coupling-target portion is warped or damaged due to the operation of connecting the intermediate conductive portion and the electrode connection portion, a risk that the warping or damage interferes with the electrode terminal is avoided or suppressed.
(4) It is preferable that, in each of the electrode connection portions, a side edge portion located near the electrode connection portion coupled via the intermediate conductive portion is bent toward an upper side that is farther from the electrode terminal than the connection portion is, and forms the coupling-target portion protruding toward the upper side with respect to the connection portion, and the coupling portions of the intermediate conductive portion are each overlaid on the coupling-target portion in a direction in which the electrode connection portion adjacent to each other approach each other or separate from each other, and coupled thereto. The coupling-target portions are each constituted by the side edge portion of the electrode connection portion that is located on the inside in a direction in which the adjacent electrode connection portions approach each other or separate from each other and is bent toward the upper side and stands upright, and the coupling portions of the intermediate conductive portion are each overlaid on and coupled to the coupling-target portion in the direction in which the adjacent electrode connection portions approach each other or separate from each other. As a result, the displacement force generated due to the displacement of the adjacent electrode terminals is likely to be applied to the elastically deformable portion provided between the coupling portions of the intermediate conductive portion, in the thickness direction of the elastically deformable portion. Accordingly, the ability to follow the displacement of the electrode terminals and the flexibility can be improved.
(5) It is preferable that, in each of the electrode connection portions, a side edge portion located near the electrode connection portion coupled via the intermediate conductive portion is bent toward an upper side that is away from the electrode terminal, is further bent toward the electrode connection portion coupled via the intermediate conductive portion, and forms the coupling-target portion that is located on the upper side with respect to the connection portion and extends parallel to the connection portion, and the coupling portions of the intermediate conductive portion are each overlaid on the coupling-target portion from the upper side and coupled thereto.

The coupling-target portions are each constituted by a portion formed by bending the side edge portion of the electrode connection portion that is located on the inside in a direction in which the adjacent electrode connection portions approach each other or separate from each other to stand toward the upper side and further bending it to extend parallel to the connection portion. This makes it possible to reliably keep the coupling-target portion at a position above and away from the electrode terminal, and even when the surface of the coupling-target portion is warped or damaged due to the operation of connecting the intermediate conductive portion and the electrode connection portion, a risk that the warping or damage interferes with the electrode terminal is more advantageously avoided or suppressed.

In addition, the coupling portions of the intermediate conductive portion each can be overlaid on, from above, the coupling-target portion extending parallel to the connection portion and coupled thereto, thus making it easier to connect the intermediate conductive portion to the electrode connection portions.
(6) It is preferable that the elastically deformable portion of the intermediate conductive portion includes at least one bent portion formed by bending the intermediate conductive portion in a thickness direction. When external force is applied in the direction in which the electrode connection portions approach each other or separate from each other, the bent portion provided in the elastically deformable portion of the intermediate conductive portion can advantageously cause bending deformation of the elastically deformable portion in the thickness direction to start at the bent portion. As a result, the elastically deformable portion is easy to elastically deform, and thus the locational shifting between the electrode terminals can be advantageously absorbed.
(7) It is preferable that the elastically deformable portion of the intermediate conductive portion includes a plurality of bent portions that are disposed at an interval in a direction in which the electrode connection portions approach each other or separate from each other and has an arch shape curved toward one side in the thickness direction as a whole. The entire elastically deformable portion has an arch shape that is curved toward one side in the thickness direction and includes a plurality of bent portions that are separated from one another in the direction in which the electrode connection portions approach each other or separate from each other. Thus, when external force is applied in the direction in which the electrode connection portions approach each other or separate from each other, the elastically deformable portion is easier to elastically deform, and the locational shifting between the electrode terminals can be advantageously absorbed.
(8) It is preferable that the intermediate conductive portion includes plate-shaped coupling portions at the two ends and the elastically deformable portion is constituted by a portion between the coupling portions, and the elastically deformable portion of the intermediate conductive portion includes four bent portions, the four bent portions includes a pair of first bent portions that are bent toward one side in the thickness direction near the coupling portions, and a pair of second bent portions that are disposed between the pair of first bent portions and are bent toward the other side in the thickness direction, and the elastically deformable portion has a gutter shape as a whole. The elastically deformable portion has a gutter shape as a whole, and includes the pair of first bent portions provided near the coupling portions, and the second bent portions that are disposed between the first bent portions and are bent toward sides opposite to the sides toward which the first bent portions are bent. Accordingly, when external force is applied in the direction in which the electrode connection portions approach each other or separate from each other, the inclination of the second bent portions in the direction in which the external force is applied is likely to start at the first bent portions, and the locational shifting between the electrode terminals can be advantageously absorbed.
(9) It is preferable that the elastically deformable portion of the intermediate conductive portion protrudes toward an upper side that is farther from the electrode terminals than the electrode connection portions are. Due to the elastically deformable portion protruding upward and being away from the electrode terminals, it is possible to advantageously prevent or suppress interference of the elastically deformable portion with portions, components, or the like near the electrode terminals while the elastically deformable portion is elastically deformed.
(10) It is preferable that the elastically deformable portion of the intermediate conductive portion is disposed on the upper side with respect to the connection portions of the electrode connection portions and protrudes downward of the coupling target portions of the electrode connection portions. A gap between the coupling-target portions, which are disposed above the connection portions of the electrode connection portions and extend parallel to the connection portions, in the direction in which the coupling-target portions are opposed to each other can be successfully used to accommodate and dispose the gutter-shaped elastically deformable portion in the orientation in which the elastically deformable portion is open upward, in the gap. This makes it possible to provide an inter-electrode-terminal connection component with an improved ability to follow the displacement of the electrode terminals without an increase in size of the inter-electrode-terminal connection component. In addition, the elastically deformable portion has a gutter shape and is disposed in the orientation in which it is open upward, and therefore, the elastically deformable portion is not elastically deformed toward the electrode terminals, and interference of the elastically deformable portion with other members, or the like is prevented or suppressed while the elastically deformable portion is elastically deformed.

### DETAILS OF EMBODIMENTS OF THE PRESENT DISCLOSURE

The following describes specific embodiments of an inter-electrode-terminal connection component of the present disclosure with reference to the drawings. Note that the present disclosure is not limited to these embodiments and is defined by the scope of the appended claims, and all changes that fall within the same essential spirit as the scope of the claims are intended to be included therein.

### Embodiment 1

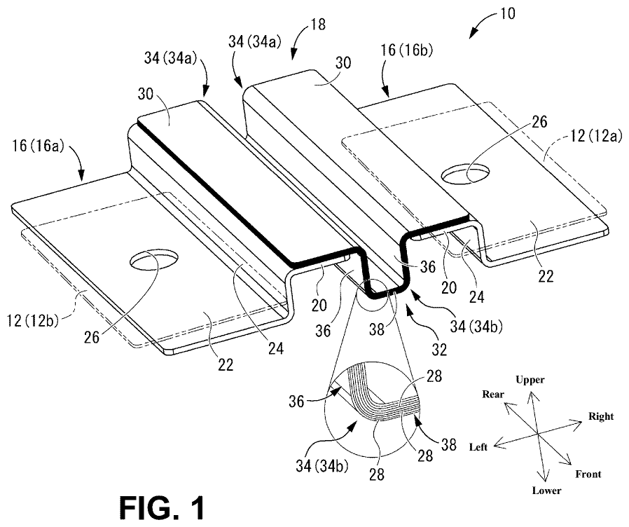

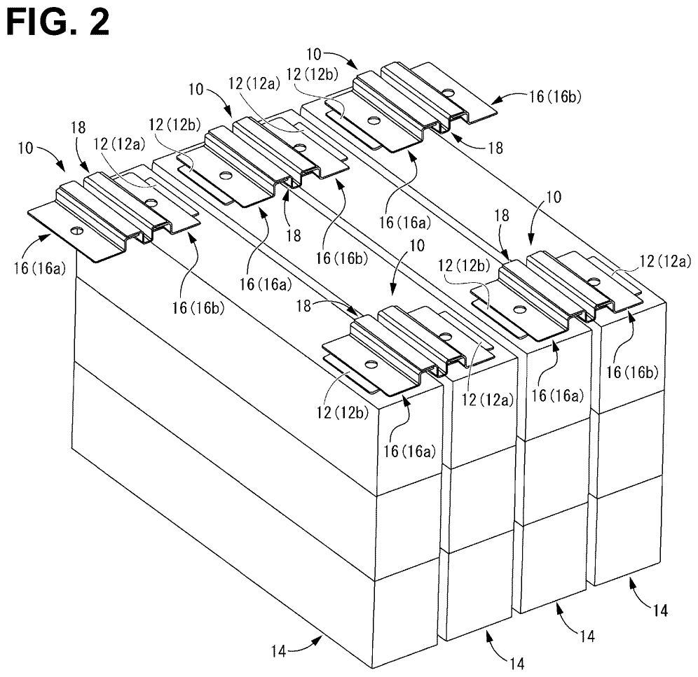

Hereinafter, Embodiment 1 of the present disclosure will be described with reference to FIGS. 1 and 2. An inter-electrode-terminal connection component 10 is a component for connecting a plurality of electrode terminals 12 adjacent to each other. Note that there is no limitation on the members that include the electrode terminals 12 and are connected to each other via the inter-electrode-terminal connection component 10, but in Embodiment 1, battery cells 14 each include a positive electrode terminal 12a and a negative electrode terminal 12b on the two sides in the front-rear direction, and the positive electrode terminal 12a and the negative electrode terminal 12b of the adjacent battery cells 14 are connected via the inter-electrode-terminal connection component 10. That is to say, in FIG. 2, a plurality of battery cells 14 are lined up in the left-right direction, and the positive electrode terminals 12a and the negative electrode terminals 12b are alternately disposed in the left-right direction on the two sides in the front-rear direction. The positive electrode terminal 12a and the negative electrode terminal 12b of the adjacent battery cells 14 are connected via the inter-electrode-terminal connection component 10, and thus the plurality of battery cells 14 are electrically connected in series.

Note that, in FIGS. 1 and 2, the positive electrode terminals 12a and the negative electrode terminals 12b are shown to have a substantially plate shape, but they may have, for example, a bolt shape protruding upward, or a threaded-hole shape that is open upward. In the inter-electrode-terminal connection components 10 located at the leftmost end and the rightmost end, a portion on a side opposite to the portion to which the electrode terminal 12 is connected may be fixed to, for example, a housing in which the plurality of battery cells 14 are accommodated, a connector, or the like (not illustrated). Although the inter-electrode-terminal connection component 10 may be disposed in any orientation, the orientation thereof will be described according to the vertical direction, the left-right direction, and the front-rear direction shown in FIG. 1 in the following description. Moreover, if identical members are included, only some of the members may be denoted by a reference numeral, and the other may not be denoted by the reference numeral.

### Inter-Electrode-Terminal Connection Component 10

The inter-electrode-terminal connection component 10 includes a plurality of electrode connection portions 16 (a first electrode connection portion 16a and a second electrode connection portion 16b) to be respectively connected to the plurality of electrode terminals 12 (the positive electrode terminal 12a and the negative electrode terminal 12b) adjacent to each other, and an intermediate conductive portion 18 that is disposed between the adjacent electrode connection portions 16 (the first electrode connection portion 16a and the second electrode connection portion 16b) and in which the electrode connection portions 16 (the first electrode connection portion 16a and the second electrode connection portion 16b) are coupled to the two ends. Note that the first electrode connection portion 16a, the second electrode connection portion 16b, and the intermediate conductive portion 18 are preferably made of a material that has excellent conductivity and is easy to process, such as copper (including a copper alloy) or aluminum (including an aluminum alloy).

### First Electrode Connection Portion 16a (Second Electrode Connection Portion 16b)

Since the first electrode connection portion 16a and the second electrode connection portion 16b are both constituted by the same member and are symmetrically disposed in the left-right direction in Embodiment 1, the following describes the first electrode connection portion 16a, and the second electrode connection portions 16b in the diagrams are denoted by the same reference numeral as that of the first electrode connection portion 16a and the detailed description of the second electrode connection portion 16b is omitted. Note that, in the inter-electrode-terminal connection component 10, the first electrode connection portion 16a and the second electrode connection portion 16b are located on the left side and the right side, respectively, and the first electrode connection portion 16a and the second electrode connection portion 16b are disposed to be opposed to each other at an interval in the left right direction. The first electrode connection portion 16a is constituted by a single flat metal plate, and is formed through bending or the like of a flat metal plate elongated in the left-right direction into a predetermined shape.

The first electrode connection portion 16a includes a plate-shaped coupling-target portion 20 to be overlaid on and coupled to a coupling portion 30 of the intermediate conductive portion 18, which will be described later, and a plate-shaped connection portion 22 to be overlaid on and connected to the electrode terminal 12 (the negative electrode terminal 12b in FIG. 1). This coupling-target portion 20 protrudes toward the upper side that is farther from the electrode terminal 12 (negative electrode terminal 12b) than the connection portion 22 is. The coupling-target portion 20 and the connection portion 22 both extend in the horizontal direction (direction orthogonal to the vertical direction).

That is to say, in the first electrode connection portion 16a, the coupling-target portion 20 is formed by bending the side edge portion located on a side (right side) near the second electrode connection portion 16b coupled via the intermediate conductive portion 18 toward the upper side with respect to the connection portion 22 located on the left side, and bending the side edge portion that has been bent toward the upper side, at an intermediate portion, toward a side (right side) near the second electrode connection portion 16b. Accordingly, the coupling-target portion 20 is disposed above the connection portion 22, both the connection portion 22 and the coupling-target portion 20 extend in the horizontal direction, and the connection portion 22 and the coupling-target portion 20 are parallel to each other. In other words, the coupling target portion 20 and the connection portion 22 are connected via a vertical portion 24 extending in the vertical direction, and the right end of the connection portion 22 is continuous with the lower end of the vertical portion 24 while the left end of the coupling-target portion 20 is continuous with the upper end of the vertical portion 24. In addition, a circular through hole 26 passing through the connection portion 22 in the thickness direction (vertical direction) is formed in the substantially central portion of the connection portion 22.

As described above, the second electrode connection portion 16b is disposed such that the second electrode connection portion 16b and the first electrode connection portion 16a are symmetrically disposed in the left-right direction and are opposed to each other at a predetermined interval in the left-right direction. That is to say, the connection portion 22 extending in the horizontal direction is provided on the right side of the second electrode connection portion 16b, and the left end of the connection portion 22 is continuous with the lower end of the vertical portion 24. The coupling-target portion 20 extends leftward from the upper end of the vertical portion 24. Accordingly, the coupling target portions 20 extend from the upper ends of the vertical portions 24 of the first electrode connection portion 16a and the second electrode connection portion 16b in the direction in which the coupling-target portions 20 approach each other, and are opposed to each other at a predetermined interval in the left-right direction.

### Intermediate Conductive Portion 18

As shown in FIG. 1, the intermediate conductive portion 18 is constituted by a laminated busbar formed by stacking a plurality of metal thin plates 28 that are thinner than the flat metal plates forming the first electrode connection portion 16a and the second electrode connection portion 16b. All the plurality of metal thin plates 28 have substantially the same shape, and the intermediate conductive portion 18 is formed by stacking, in the vertical direction, a plurality of metal thin plates 28 having a substantially rectangular shape elongated in the left-right direction and bending the resulting laminate into a predetermined shape. Note that the intermediate conductive portion 18 may also be formed by stacking, in the vertical direction, a plurality of metal thin plates 28 bent into a predetermined shape. Although there is no limitation on the thickness and the number of the metal thin plates 28 to be stacked, metal thin plates 28 having a thickness within a range of 0.1 mm to 0.6 mm are stacked, and the number of the metal thin plates 28 is within a range of 6 to 12, for example.

Although this enables elastic deformation of the overall intermediate conductive portion 18 in a single-item state, which means a state in which the intermediate conductive portion 18 is not fixed to the first electrode connection portion 16a and the second electrode connection portion 16b yet, but the two ends of the intermediate conductive portion 18 in the left-right direction are formed as plate-shaped coupling portions 30 and are not capable of being elastically deformed after being overlaid on and fixed to the coupling-target portions 20 as described later. In addition, the intermediate portion of the intermediate conductive portion 18 in the left right direction is formed as an elastically deformable portion 32 that is not fixed to the coupling-target portions 20 and can be easily elastically deformed. As described later, the displacement of the first electrode connection portion 16a and the second electrode connection portion 16b approaching each other or separating from each other can be accepted by the elastically deformable portion 32 being elastically deformed. That is to say, in the intermediate conductive portion 18, the elastically deformable portion 32 is formed between the coupling portions 30 located at the two ends in the left-right direction.

The elastically deformable portion 32 includes, for example, at least one bent portion 34, and is bent in the thickness direction at the bent portion 34. In Embodiment 1, the elastically deformable portion 32 includes four bent portions 34, and has a substantially gutter shape as a whole. That is to say, the four bent portions 34 include a pair of first bent portions 34a that are bent toward the lower side, which is one side in the thickness direction (vertical direction), near the coupling portions 30, and the elastically deformable portion 32 includes a pair of side wall portions 36 that are continuous with the coupling portions 30 and extend downward. In Embodiment 1, the pair of side wall portions 36 extend parallel to the vertical direction in the single-item state of the inter-electrode-terminal connection component 10, which means a state in which it is not connected to the positive electrode terminal 12a and the negative electrode terminal 12b yet, and in a state in which the inter-electrode-terminal connection component 10 is connected to the positive electrode terminal 12a and the negative electrode terminal 12b, but the side wall portions may extend in a direction inclined with respect to the vertical direction in both states.

A pair of second bent portions 34b, which are the remaining two of the four bent portions 34, are provided at the lower ends of the pair of side wall portions 36, and the lower ends of the pair of side wall portions 36 are bent toward the inside in the left-right direction, which is the other side in the thickness direction (left-right direction). In short, in the elastically deformable portion 32, the lower ends of the pair of side wall portions 36 are bent at the second bent portions 34b, and a bottom wall portion 38 that connects the lower ends of the pair of side wall portions 36 is provided. The elastically deformable portion 32 having a substantially gutter shape that is open upward is constituted by the pair of side wall portions 36 and the bottom wall portion 38.

Note that, in the state in which the intermediate conductive portion 18 is not bent at the bent portions 34 (i.e., the state in which the metal thin plates 28 elongated in the left-right direction are stacked in the vertical direction), portions for forming the pair of first bent portions 34a and portions for forming the pair of second bent portions 34b are disposed at intervals therebetween in the left-right direction, which is the direction in which the first electrode connection portion 16a and the second electrode connection portion 16b approach each other or separate from each other. The pair of second bent portions 34b are disposed between the pair of first bent portions 34a. On the basis of the state in which the intermediate conductive portion 18 extends in the left-right direction, it is understood that the elastically deformable portion 32 is formed by bending the intermediate conductive portion 18 at the pair of first bent portions 34a toward the lower side, which is one side in the thickness direction, and then bending the intermediate conductive portion 18 at the pair of second bent portions 34b toward the upper side, which is the other side in the thickness direction.

### Step of Assembling Inter-Electrode-Terminal Connection Component 10

Subsequently, a specific example of a step of assembling the inter-electrode-terminal connection component 10 will be described. Note that the step of assembling the inter-electrode-terminal connection component 10 is not limited to the following description.

First, the first electrode connection portion 16a is obtained by bending one flat metal plate into the shape described above. Note that, since the first electrode connection portion 16a and the second electrode connection portion 16b have the same shape, the second electrode connection portion 16b can be simultaneously formed by forming a plurality of first electrode connection portions 16a. Thus, the first electrode connection portion 16a and the second electrode connection portion 16b are obtained.

Next, the intermediate conductive portion 18 is obtained by stacking a plurality of metal thin plates 28 and bending the resulting laminate into the shape described above. Then, the elastically deformable portion 32 of the intermediate conductive portion 18 is inserted between the coupling-target portions 20 of the first electrode connection portion 16a and the second electrode connection portion 16b, and the coupling portions 30 of the intermediate conductive portion 18 are overlaid on the coupling-target portions 20 from above and fixed thereto. Note that, although there is no limitation on a method for fixing the coupling portions 30 to the coupling target portions 20, conventionally known fixing methods such as ultrasonic welding, laser welding, bonding, and use of fastening components can be employed. Thus, the intermediate conductive portion 18 is fixed to the first electrode connection portion 16a and the second electrode connection portion 16b, and the inter-electrode-terminal connection component 10 is completed.

In the inter-electrode-terminal connection component 10 of Embodiment 1, the elastically deformable portion 32 of the intermediate conductive portion 18 protrudes below the coupling-target portions 20 of the first electrode connection portion 16a and the second electrode connection portion 16b, and the lower surface of the bottom wall portion 38, which corresponds to the lower end of the elastically deformable portion 32, is located slightly above the lower surfaces of the connection portions 22. Accordingly, the elastically deformable portion 32 of the intermediate conductive portion 18 is disposed above the connection portions 22 of the first electrode connection portion 16a and the second electrode connection portion 16b.

In the thus produced inter-electrode-terminal connection component 10, one of the first electrode connection portion 16a and the second electrode connection portion 16b is overlaid on and electrically connected to one of the positive electrode terminal 12a and the negative electrode terminal 12b of the battery cell 14, and the other of the first electrode connection portion 16a and the second electrode connection portion 16b is overlaid on and electrically connected to the other of the positive electrode terminal 12a and the negative electrode terminal 12b of the adjacent battery cell 14. Thus, as shown in FIG. 2, a plurality of battery cells 14 adjacent to one another in the left-right direction are connected in series via a plurality of inter-electrode-terminal connection components 10.

Note that there is no limitation on the method for electrically connecting the first electrode connection portion 16a and the second electrode connection portion 16b to the positive electrode terminal 12a and the negative electrode terminal 12b, and, for example, the first electrode connection portion 16a and the second electrode connection portion 16b may be overlaid on metal electrode terminals 12a and 12b and fixed thereto through laser welding or the like. Alternatively, if the electrode terminals 12a and 12b have a bolt shape and protrude upward, the first electrode connection portion 16a and the second electrode connection portion 16b may be fixed to the electrode terminals 12a and 12b by, for example, inserting the bolts into the through holes 26 of the first electrode connection portion 16a and the second electrode connection portion 16b and fastening nuts to the bolts. Also, if the electrode terminals 12a and 12b have a threaded-hole shape, the first electrode connection portion 16a and the second electrode connection portion 16b may be fixed to the electrode terminals 12a and 12b by fastening bolts from above through the through holes 26 of the first electrode connection portion 16a and the second electrode connection portion 16b. Note that the through holes 26 of the first electrode connection portion 16a and the second electrode connection portion 16b can be used for not only insertion of bolts but also monitoring during laser welding.

In the inter-electrode-terminal connection component 10 of Embodiment 1, the first electrode connection portion 16a and the second electrode connection portion 16b to be connected to the positive electrode terminal 12a and the negative electrode terminal 12b are each constituted by one flat metal plate and are rigid to some extent. Accordingly, a risk is reduced that the first electrode connection portion 16a and the second electrode connection portion 16b are accidentally deformed and thus a gap is generated between the first electrode connection portion 16a or the second electrode connection portion 16b and the positive electrode terminal 12a or the negative electrode terminal 12b, and the state in which the positive electrode terminal 12a and the negative electrode terminal 12b are in electrical communication with the first electrode connection portion 16a and the second electrode connection portion 16b can be stably maintained.

In addition, the intermediate conductive portion 18 via which the first electrode connection portion 16a and the second electrode connection portion 16b are coupled includes the elastically deformable portion 32 that is capable of being elastically deformed. Thus, even when the positions of the positive electrode terminal 12a and the negative electrode terminal 12b are shifted due to, for example, a volume change caused by thermal expansion or the like, the displacement of the first electrode connection portion 16a and the second electrode connection portion 16b that follows the electrode terminals 12a and 12b is accepted by the elastically deformable portion 32 being elastically deformed. As a result, even when locational shifting of the electrode terminals 12a and 12b occurs, the state in which the electrode terminals 12a and 12b are in electrical communication with the first electrode connection portion 16a and the second electrode connection portion 16b can be stably maintained. Note that, in Embodiment 1, if displacement of the positive electrode terminal 12a and the negative electrode terminal 12b occurs in the direction in which these electrode terminals approach each other, displacement of the first electrode connection portion 16a and the second electrode connection portion 16b will occur in the direction in which these electrode connection portions approach each other, and the elastically deformable portion 32 having a substantially gutter shape will be elastically deformed such that the opening size of the upper opening decreases.

The intermediate conductive portion 18 includes the plate-shaped coupling portions 30 at the two ends, and the elastically deformable portion 32 provided between the coupling portions 30. The first electrode connection portion 16a and the second electrode connection portion 16b each include the coupling-target portion 20 and the connection portion 22, which both have a plate shape. Thus, when the positive electrode terminal 12a and the negative electrode terminal 12b are connected to the first electrode connection portion 16a and the second electrode connection portion 16b, or the coupling-target portions 20 are connected to the coupling portions 30, large contact areas can also be secured, and favorable electrical communication is achieved. Since the elastically deformable portion 32 is not fixed to the first electrode connection portion 16a and the second electrode connection portion 16b, the flexibility of the elastically deformable portion 32 is not impaired, and the elastically deformable portion 32 can stably follow the locational shifting of the positive electrode terminal 12a and the negative electrode terminal 12b and be deformed.

In the first electrode connection portion 16a and the second electrode connection portion 16b, the coupling target portions 20 protrude above the connection portions 22. Thus, even when the lower surfaces of the coupling-target portions 20 are roughened, leading to generation of unevenness or scratches, while, for example, fixing the coupling target portions 20 to the coupling portions 30 through welding, a situation is avoided in which the protrusions formed on the lower surfaces of the coupling-target portions 20 come into contact with the electrode terminals 12a and 12b and battery cell 14 and thus have adverse influence on the connection of the positive electrode terminal 12a and the negative electrode terminal 12b to the first electrode connection portion 16a and the second electrode connection portion 16b.

In particular, in the first electrode connection portion 16a and the second electrode connection portion 16b, the coupling-target portions 20 and the connection portions 22 horizontally extend, and are parallel to one another. This makes it possible to reduce the size of the inter-electrode-terminal connection component 10 in the vertical direction compared to a case where, for example, the coupling-target portions 20 extend from the vertical portions 24 while being inclined upward, and also makes it easy to fix the coupling-target portions 20 to the coupling portions 30 compared to a case where, for example, the coupling-target portions 20 extend from the vertical portions 24 while being inclined downward.

The elastically deformable portion 32 of Embodiment 1 includes four bent portions 34, specifically the pair of first bent portions 34a and the pair of second bent portions 34b. If displacement of the two electrode terminals 12a and 12b occurs in the direction in which these electrode terminals approach each other, the elastically deformable portion 32 having a substantially gutter shape will be elastically deformed such that the opening size of the upper opening decreases as described above, where this elastic deformation is achieved due to inclination of the side wall portions 36 with respect to the vertical direction starting at the first bent portions 34a and the second bent portions 34b. That is to say, portions that is preferentially deformed can be provided in the elastically deformable portion 32 by forming the bent portions 34, thus making it easier to elastically deform the elastically deformable portion 32 so as to follow the displacement of the two electrode terminals 12a and 12b.

In Embodiment 1, the first electrode connection portion 16a and the second electrode connection portion 16b each include the coupling-target portion 20 protruding upward, and the elastically deformable portion 32 of the intermediate conductive portion 18 is located between the coupling-target portions 20 and protrudes downward. In particular, in Embodiment 1, the lower surface of the bottom wall portion 38 of the elastically deformable portion 32 is located above the lower surfaces of the connection portions 22 of the first electrode connection portion 16a and the second electrode connection portion 16b. That is to say, the elastically deformable portion 32 is accommodated in the space formed due to the coupling-target portions 20 of the first electrode connection portion 16a and the second electrode connection portion 16b protruding upward, thus making it possible to reduce the vertical size of the inter-electrode-terminal connection component 10 and avoid interference of the elastically deformable portion 32 with the battery cell 14, which is located below the inter-electrode-terminal connection component 10.

### Embodiment 2

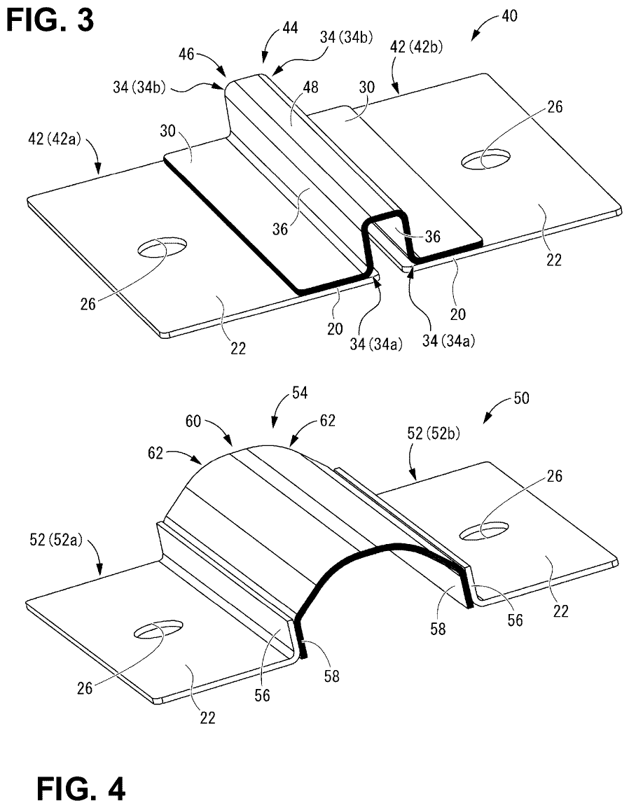

Next, Embodiment 2 of the present disclosure will be described with reference to FIG. 3. An inter-electrode-terminal connection component 40 of Embodiment 2 basically has the same structure as that of the inter-electrode-terminal connection component 10 of Embodiment 1, and includes a pair of electrode connection portions 42 (a first electrode connection portion 42a and a second electrode connection portion 42b) that are away from each other in the left-right direction and is opposed to each other, and an intermediate conductive portion 44 via which the first electrode connection portion 42a and the second electrode connection portion 42b are coupled. The first electrode connection portion 42a and the second electrode connection portion 42b are each constituted by one flat metal plate, and the intermediate conductive portion 44 is constituted by a laminated busbar formed by stacking a plurality of metal thin plates 28. In the following description, the same members and portions as those in the embodiment above are denoted by the same reference numerals as those in the embodiment above in the diagrams, and the detailed descriptions are omitted. The first electrode connection portion 42a and the second electrode connection portion 42b of Embodiment 2 are not provided with bent portions, and has a plate shape that is flat as a whole. In the first electrode connection portion 42a and the second electrode connection portion 42b, portions on the inner side in the direction in which these electrode connection portions are opposed to each other serve as the plate-shaped coup ling-target portions 20, and portions on the outer side in the direction in which these electrode connection portions are opposed to each other serve as the plate-shaped connection portions 22.

The elastically deformable portion 32 of Embodiment 1 has a substantially gutter shape that is open upward, whereas the elastically deformable portion 46 of Embodiment 2 has a substantially gutter shape that is open downward. In short, the elastically deformable portion 46 of Embodiment 2 protrudes toward the upper side that is farther from the electrode terminals 12a and 12b than the first electrode connection portion 42a and the second electrode connection portion 42b are. That is to say, the intermediate conductive portion 44 of Embodiment 2 includes the plate-shaped coupling portions 30 at the two ends in the left-right direction, and the side wall portions 36 extending upward from the ends of the coupling portions 30 on the inner side in the direction in which the coupling portions 30 are opposed to each other, and the upper ends of the side wall portions 36 are connected via a top wall portion 48. The coupling portions 30 are connected to the side wall portions 36 via the first bent portions 34a included in the bent portions 34, while the side wall portions 36 are connected to the top wall portion 48 via the second bent portions 34b included in the bent portions 34.

The inter-electrode-terminal connection component 40 of Embodiment 2 having the structure as described above can also exhibit the same effect as that of the inter-electrode-terminal connection component 10 of Embodiment 1. In particular, in the inter-electrode-terminal connection component 40 of Embodiment 2, the elastically deformable portion 46 protrudes upward, namely in the direction away from the electrode terminals 12a and 12b, thus making it possible to avoid interference with a member such as the battery cell 14, which is located below the inter-electrode-terminal connection component 40. In addition, since the elastically deformable portion 46 is not located between the electrode connection portions 42a and 42b, the distance between the electrode connection portions 42a and 42b opposed to each other in the left-right direction can also be reduced, and the size of the inter-electrode-terminal connection component 40 in the left-right direction can be reduced.

### Embodiment 3

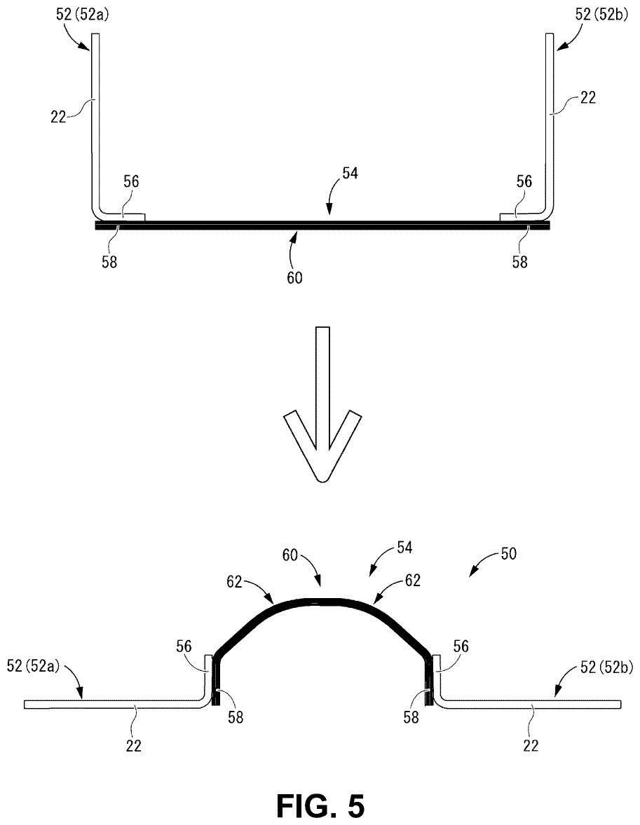

Next, Embodiment 3 of the present disclosure will be described with reference to FIGS. 4 and 5. An inter-electrode-terminal connection component 50 of Embodiment 3 also includes a pair of electrode connection portions 52 (a first electrode connection portion 52a and a second electrode connection portion 52b) that are away from each other in the left-right direction and is opposed to each other, and an intermediate conductive portion 54 via which the first electrode connection portion 52a and the second electrode connection portion 52b are coupled. The first electrode connection portion 52a and the second electrode connection portion 52b are each constituted by one flat metal plate, and the intermediate conductive portion 54 is constituted by a laminated busbar formed by stacking a plurality of metal thin plates 28.

In the first electrode connection portion 52a and the second electrode connection portion 52b of Embodiment 3, side edge portions on the inner side in the direction in which these electrode connection portions are opposed to each other, namely side edge portions near the second electrode connection portion 52b and the first electrode connection portion 52a coupled via the intermediate conductive portion 54, are bent toward the upper side that is farther from the electrode terminals 12a and 12b than the connection portions 22 located on the outer side in the direction in which these electrode connection portions are opposed are, and the portions that are bent and protrude toward the upper side form coupling-target portions 56. That is to say, the first electrode connection portion 52a and the second electrode connection portion 52b have a substantially L-shaped cross-section.

The intermediate conductive portion 54 of Embodiment 3 includes plate-shaped coupling portions 58 to be overlaid on and coupled to the coupling-target portions 56, at the two ends in the left-right direction, and an elastically deformable portion 60 capable of being elastically deformed is provided between the coupling portions 58 in the left-right direction. The coupling portions 58 extend in the vertical direction, and are overlaid on and fixed to the coupling-target portions 56 from the inner side in the left-right direction, which is a direction in which the electrode connection portions 52a and 52b approach each other or separate from each other. The same method as the method for fixing the coupling portions 30 to the coupling-target portions 20 described in Embodiment 1 above can be employed as a method for fixing the coupling portions 58 to the coupling-target portions 56.

The elastically deformable portion 60 of Embodiment 3 has an arch shape that is curved so as to protrude toward the upper side, which is one side in the thickness direction, as a whole. Note that the elastically deformable portion 60 of Embodiment 3 includes some planar portions, and a plurality of bent portions 62 that are away from one another in the left-right direction, which is a direction in which the electrode connection portions 52a and 52b approach each other or separate from each other, and couple the planar portions. An elastically deformable portion having an arch shape may have a configuration in which some of the portions thereof are the planar portions while portions other than the planar portions are the bent portions 62 as in Embodiment 3, but the elastically deformable portion may include no planar portions and be curved in its entirety. In this case, the curvature of the elastically deformable portion may be constant in the left-right direction, or may be partially different in the left-right direction. In addition, when the elastically deformable portion is curved in its entirety, it can also be considered that numerous bent portions are provided in the left-right direction.

As in the case of the inter-electrode-terminal connection component 10 of Embodiment 1, the inter electrode-terminal connection component 50 of Embodiment 3 may be produced by bending the intermediate conductive portion 54 into the shape as described above before overlaying the coupling portions 58 of the intermediate conductive portion 54 on the coupling-target portions 56 of the first electrode connection portion 52a and the second electrode connection portion 52b and fixing the coupling portions 58 to the coupling target portions 56, but can be produced using, for example, a method illustrated in FIG. 5.

Specifically, first, as shown in the upper panel of FIG. 5, the coupling-target portions 56 of the first electrode connection portion 52a and the second electrode connection portion 52b are overlaid, from above, on the coupling portions 58 at both the left end and the right end of the intermediate conductive portion 54 in a state in which the metal thin plates 28 are stacked in the vertical direction (a state in which the intermediate conductive portion 54 is not bent at the bent portions 62 yet). In this state, the connection portions 22 of the first electrode connection portion 52a and the second electrode connection portion 52b extend upward from the coupling target portions 56. When, for example, the coupling-target portions 56 are fixed to the coupling portions 58 through ultrasonic welding in the state in which the coupling-target portions 56 are overlaid on the coupling portions 58 in the vertical direction in this manner, the spaces can be secured on both the upper side and the lower side of the portions where the coupling-target portions 56 are overlaid on the coupling portions 58, and a horn for supersonic welding can be overlaid on the portions where the coupling-target portions 56 are overlaid on the coupling portions 58 from one of the upper side and the lower side. Thus, the coupling target portions 56 can be easily fixed to the coupling portions 58.

Thereafter, as shown in the lower panel of FIG. 5, the elastically deformable portion 60 of the intermediate conductive portion 54 is bent into the shape as described above, and thus the inter-electrode-terminal connection component 50 of Embodiment 3 is completed. Note that, in the inter-electrode-terminal connection component 50 shown in the lower panel of FIG. 5, the connection portions 22 of the first electrode connection portion 52a and the second electrode connection portion 52b extend in the horizontal direction, but, for example, in the state in which the inter-electrode-terminal connection component 50 is not attached to the battery cell 14 yet, the inter-electrode-terminal connection component 50 may be brought into a state in which, for example, one of the connection portions 22 is located above the other, by reducing the bending amount of the elastically deformable portion 60 compared to a predetermined bending amount. When the inter-electrode-terminal connection component is attached to the battery cell 14, the connection portions 22 may be brought into a state of extending in the horizontal direction by additionally bending the elastically deformable portion 60, and then overlaid on the electrode terminals 12a and 12b.

The inter-electrode-terminal connection component 50 of Embodiment 3 having the structure as described above can also exhibit the same effect as that of the inter-electrode-terminal connection component 10 of Embodiment 1. In particular, the elastically deformable portion 60 of intermediate conductive portion 54 of Embodiment 3 has an arch shape protruding upward, and when, for example, displacement of the electrode connection portions 52a and 52b occurs in the direction in which the electrode connection portions 52a and 52b approach each other, elastic deformation leading to compression of the elastically deformable portion 60 in the left right direction is likely to occur. As a result, the displacement of the first electrode connection portion 52a and the second electrode connection portion 52b that follows the electrode terminals 12a and 12b is stably accepted by the elastically deformable portion 60 being elastically deformed. In addition, due to the coupling portions 58 being overlaid on the coupling-target portions 56 in the left-right direction and fixed thereto, a situation in which, for example, protrusions included in roughness, scratches, and the like on the inner surfaces of the coupling portions 58 that are generated due to the fixing process interfere with the electrode terminals 12a and 12b and the battery cell 14 is a voided.

As described above, the inter electrode-terminal connection component 50 of Embodiment 3 can also be produced using the method illustrated in FIG. 5. Using this production method makes it easy to fix the coupling target portions 56 to the coupling portions 58, which leads to an improvement of the production efficiency of the inter-electrode-terminal connection component 50.

### Modified Example of Embodiment 3

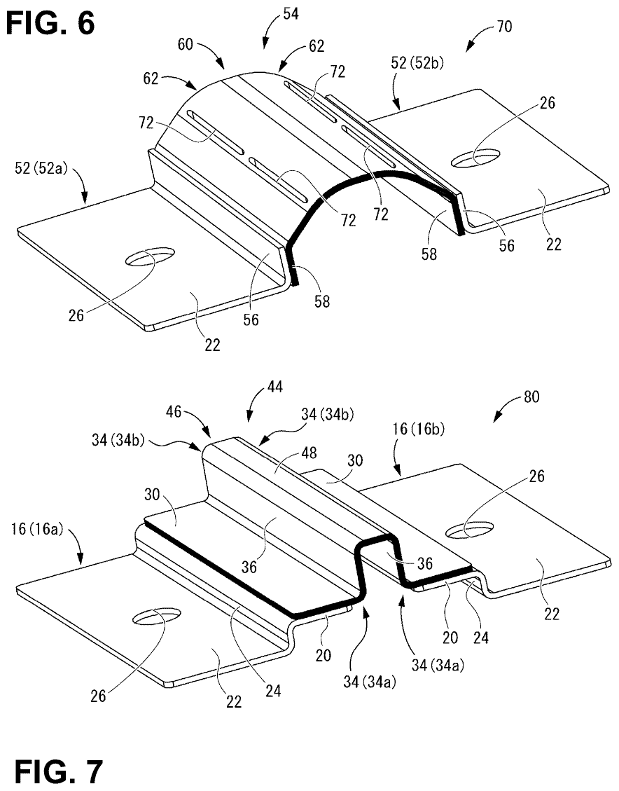

Next, a modified example of Embodiment 3 of the present disclosure will be described with reference to FIG. 6. In an electrode terminal connection component 70 shown in FIG. 6, the elastically deformable portion 60 of the intermediate conductive portion 54 of the inter-electrode-terminal connection component 70 of Embodiment 3 is provided with slits 72 passing through the elastically deformable portion 60 in the thickness direction. Although there is no limitation on the shape and the number of the slits 72, four slits 72 in total are provided at intervals in the front-rear direction and the left right direction, each slit 72 having an elongated hole shape with the size in the front-rear direction being larger than the size in the left-right direction. The slits 72 each may be provided in the bent portion 62 or the planar portion in the elastically deformable portion 60.

Providing the elastically deformable portion 60 with the slits 72 in this manner makes it possible to reduce reaction force (springback) caused by the deformation of the elastically deformable portion 60. That is to say, when the inter-electrode-terminal connection component 70 is formed by altering the shape of the elastically deformable portion 60, for example, as shown in FIG. 5 above, elastic restoring force to bring the elastically deformable portion 60 to the state shown in the upper panel of FIG. 5 will be applied to the elastically deformable portion 60 as biasing force. Thus, biasing force is applied to the coupling portions 58 of the intermediate conductive portion 54 in the direction in which the coupling portions 58 separate from each other, and thus biasing force to bring the elastically deformable portion 60 to the state shown in the upper panel of FIG. 5 is also applied to the first electrode connection portion 52a and the second electrode connection portion 52b. Therefore, providing the elastically deformable portion 60 with the slits 72 as in the case of this aspect makes it easy to alter the shape of the elastically deformable portion 60 from the shape shown in the upper panel of FIG. 5 to the shape shown in the lower panel of FIG. 5, and makes it possible to reduce the biasing force in the direction in which the elastically deformable portion 60 is restored to the state shown in the upper panel of FIG. 5. Thus, a situation in which one of the first electrode connection portion 52a and the second electrode connection portion 52b is located above the other can be suppressed, thus making it possible to stably connect the electrode connection portions 52a and 52b to the electrode terminals 12a and 12b. Note that, although the slits 72 extending in the front-rear direction are employed in this aspect, slits extending, for example, in the left-right direction may be employed instead of or in addition to the slits 72 extending in the front-rear direction.

### Embodiment 4

Next, Embodiment 4 of the present disclosure will be described with reference to FIG. 7. An inter-electrode-terminal connection component 80 of Embodiment 4 has a structure in which the first electrode connection portion 16a and the second electrode connection portion 16b of Embodiment 1, and the intermediate conductive portion 44 of Embodiment 2 are used in combination, and the reference numerals thereof are used in FIG. 7 and the detailed descriptions thereof are omitted.

Briefly, the first electrode connection portion 16a and the second electrode connection portion 16b of the inter-electrode-terminal connection component 80 of Embodiment 4 each include the connection portion 22 and the coupling-target portion 20 located above the connection portion 22, and the coupling portions 30 located at the two ends of the intermediate conductive portion 44 in the left-right direction are overlaid on and fixed to the coupling-target portions 20. In the intermediate conductive portion 44, the elastically deformable portion 46 having a substantially gutter shape protruding upward is provided between the coupling portions 30.

The inter-electrode-terminal connection component 80 of Embodiment 4 having the structure as described above can also exhibit the same effect as that of the inter-electrode-terminal connection component 10 of Embodiment 1. In particular, in the first electrode connection portion 16a and the second electrode connection portion 16b, the coupling-target portions 20 are located above the connection portions 22, and therefore, even when protrusions are generated due to the lower surfaces of the coupling-target portions 20 being roughened or scratched during the fixing of the coupling portions 30, interference of the protrusions with the electrode terminals 12a and 12b and the battery cell 14 is avoided. In addition, since the elastically deformable portion 46 protrudes upward, interference of the elastically deformable portion 46 with the electrode terminals 12a and 12b and the battery cell 14 is also avoided. Also, since the elastically deformable portion 46 is not located between the coupling-target portions 20, the size between the coupling-target portions 20 opposed to each other in the left-right direction can be reduced, and thus the size of the inter electrode-terminal connection component 80 in the left-right direction can also be reduced.

### Embodiment 5

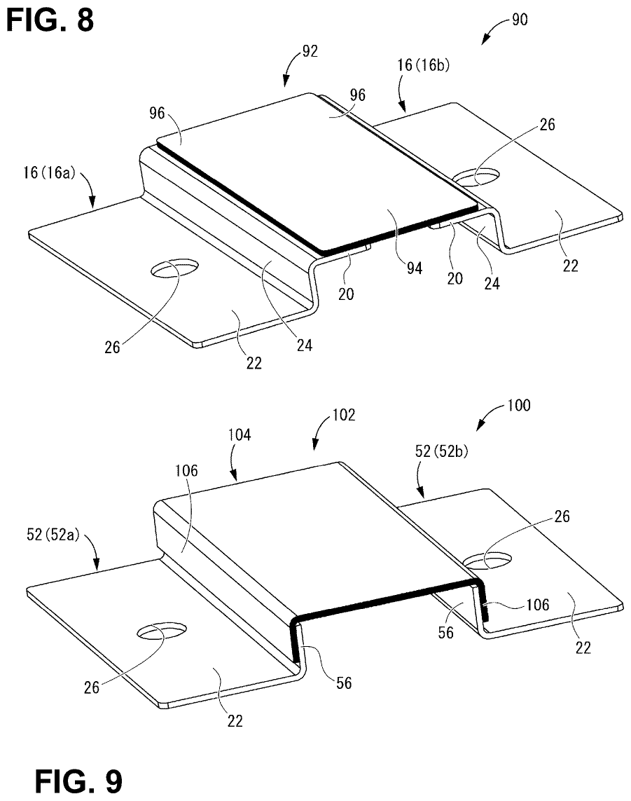

Next, Embodiment 5 of the present disclosure will be described with reference to FIG. 8. The elastically deformable portions 32, 46, and 60 of the intermediate conductive portions 18, 44, and 54 protrude above or below the coupling portions 30 and 58 located at the left end and the right end in Embodiments 1 to 4 above, but, in an inter-electrode-terminal connection component 90 of Embodiment 5, an elastically deformable portion 94 of an intermediate conductive portion 92 does not protrude above or below coupling portions 96 at the left end and the right end, and the intermediate conductive portion 92 extends in the horizontal direction and is substantially flat. Note that the first and second electrode connection portions of Embodiment 5 have the same structure as that of the first electrode connection portion 16a and the second electrode connection portion 16b of Embodiment 1, and therefore, the same reference numerals as those for the first electrode connection portion 16a and the second electrode connection portion 16b of Embodiment 1 are used in FIG. 8 and the detailed descriptions thereof are omitted.

As described above, the intermediate conductive portion 92 has a substantially flat rectangular plate shape, and portions at the left side and the right side thereof are coupling portions 96 to be overlaid on the coupling-target portions 20 of the first electrode connection portion 16a and the second electrode connection portion 16b while a portion that is located between the coupling portions 96 and is not to be overlaid on the coupling-target portions 20 is an elastically deformable portion 94. Since the elastically deformable portion 94 is not fixed to the coupling target portions 20, the elastically deformable portion 94 is capable of being elastically deformed so as to protrude toward one side in the thickness direction (vertical direction) when, for example, displacement of the first electrode connection portion 16a and the second electrode connection portion 16b occurs in the direction in which the first electrode connection portion 16a and the second electrode connection portion 16b approach each other.

The inter-electrode-terminal connection component 90 of Embodiment 5 having the structure as described above can also exhibit the same effect as that of the inter-electrode-terminal connection component 10 of Embodiment 1. In particular, the intermediate conductive portion 92 of Embodiment 5 can be formed by stacking the metal thin plates 28 having a substantially rectangular shape in the vertical direction, and processing for bending the intermediate conductive portion 92 into a predetermined shape through pressing or the like, and others are not needed. Accordingly, the intermediate conductive portion 92 can be easily formed, and thus the production efficiency of the inter-electrode-terminal connection component 90 can be improved.

### Embodiment 6

Next, Embodiment 6 of the present disclosure will be described with reference to FIG. 9. In an inter-electrode-terminal connection component 100 of Embodiment 6, an elastically deformable portion 104 of an intermediate conductive portion 102 has a substantially flat rectangular plate shape extending in the horizontal direction as in the case of the inter-electrode-terminal connection component 90 of Embodiment 5. Note that the first and second electrode connection portions of Embodiment 6 have the same structure as that of the first electrode connection portion 52a and the second electrode connection portion 52b of Embodiment 3, and therefore, the same reference numerals as those for the first electrode connection portion 52a and the second electrode connection portion 52b of Embodiment 3 are used in FIG. 9 and the detailed descriptions thereof are omitted.

That is to say, the first electrode connection portion 52a and the second electrode connection portion 52b each include the connection portion 22 on the outer side in the left-right direction, and the coupling target portion 56 protruding upward at an end of the connection portion 22 on the inner side in the left-right direction. In the intermediate conductive portion 102, coupling portions 106 to be overlaid on the coupling-target portions 56 from the outer side in the left-right direction and fixed thereto are provided at the two ends of the elastically deformable portion 104 in the left-right direction. In the intermediate conductive portion 102, a portion between the coupling portions 106 corresponds to the elastically deformable portion 104, and the coupling portions 106 protrude downward from the two ends of the elastically deformable portion 104 in the left-right direction. With this configuration, the coupling portions 106 of the intermediate conductive portion 102 are overlaid on the coupling-target portions 56 and are thus substantially incapable of being elastically deformed. In addition, since the elastically deformable portion 104 is not fixed to the coupling-target portions 56, the elastically deformable portion 104 is capable of being elastically deformed so as to protrude toward one side in the thickness direction (vertical direction) when, for example, displacement of the first electrode connection portion 52a and the second electrode connection portion 52b occurs in the direction in which the first electrode connection portion 52a and the second electrode connection portion 52b approach each other.

The inter-electrode-terminal connection component 100 of Embodiment 6 having this structure may be formed by bending the intermediate conductive portion 102 into the shape as described above before overlaying the coupling-target portions 56 of the first electrode connection portion 52a and the second electrode connection portion 52b on the inner surfaces of the coupling portions 106 and fixing the coupling target portions 56 thereto, but, as in the case of Embodiment 3 above shown in FIG. 5, the inter-electrode-terminal connection component 100 may be formed by overlaying the coupling-target portions 56 on the coupling portions 106 at the two ends of the substantially flat intermediate conductive portion 102 in the left right direction and fixing the coupling-target portions 56 thereto before bending the intermediate conductive portion 102 into the shape described above. Note that the intermediate conductive portion 102 may be bent such that the elastically deformable portion 104 is kept flat, but elastically deformable portion 104 may be, for example, curved so as to protrude upward by bending the intermediate conductive portion 102. Elastic restoring force (springback) is generated against such bending of the intermediate conductive portion 102, but the elastically deformable portion 104 may be provided with slits as in the case of the inter-electrode-terminal connection component 70 shown in FIG. 6, so that the elastic restoring force is reduced and thus the shape of the inter-electrode-terminal connection component 100 can be stably maintained.

The inter-electrode-terminal connection component 100 of Embodiment 6 having the structure as described above can also exhibit the same effect as that of the inter-electrode-terminal connection component 10 of Embodiment 1. In particular, since the coupling portions 106 are overlaid on the coupling-target portions 56 in the left-right direction and fixed thereto, a situation in which, for example, protrusions included in roughness, scratches, and the like on the inner surfaces of the coupling-target portions 56 that are generated due to the fixing process interfere with the electrode terminals 12a and 12b and the battery cell 14 is avoided. In addition, since the elastically deformable portion 104 is substantially flat, the size of the inter-electrode-terminal connection component 100 in the vertical direction is reduced, and interference of the elastically deformable portion 104 with the electrode terminals 12a and 12b and the battery cell 14 is avoided. Since the inter-electrode-terminal connection component 100 can be produced using the same method as the method illustrated in FIG. 5 above, the coupling portions 106 can be easily fixed to the coupling target portions 56, which leads to an improvement of the production efficiency of the inter-electrode-terminal connection component 100.

### OTHER EMBODIMENTS

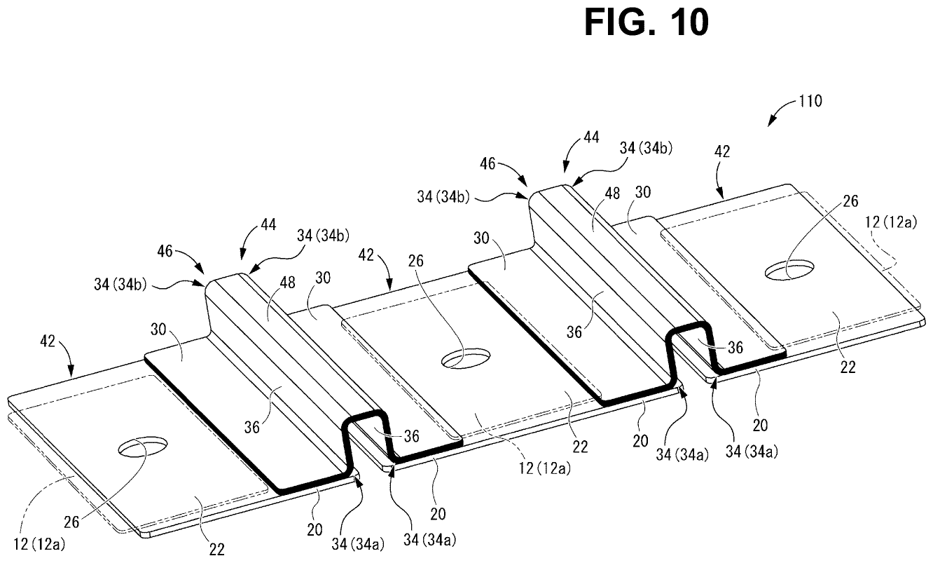

The technology described in this specification is not limited to the embodiments described by the descriptions above and the drawings, and, for example, the following embodiments are also included in the technical scope of the technology described in this specification.
(1) The battery cells 14 are electrically connected in series by connecting the positive electrode terminal 12a and the negative electrode terminal 12b of the adjacent battery cells 14 via the inter-electrode-terminal connection component 10, 40, 50, 70, 80, 90, or 100 in the embodiments above, but, for example, the positive electrode terminals or the negative electrode terminals of the adjacent battery cells may be connected via the inter-electrode-terminal connection component, or the battery cells may be electrically connected in parallel. In this case, the inter-electrode-terminal connection component is not limited to, for example, an aspect that connects two adjacent electrode terminals, and may include three electrode connection portions 42 for connecting three adjacent electrode terminals 12 (positive electrode terminals 12a in FIG. 10), the adjacent electrode connection portions 42 being coupled via the intermediate conductive portion 44, as in the case of an inter-electrode-terminal connection component 110 shown in FIG. 10, or may include four or more electrode connection portions 42 for connecting four or more adjacent electrode terminals. Note that, although the inter-electrode-terminal connection component 110 shown in FIG. 10 has a shape obtained by coupling two inter-electrode-terminal connection components 40 of Embodiment 2 above, a plurality of different inter-electrode-terminal connection components described in the embodiments above may be used in combination for an inter-electrode-terminal connection component, for example, in accordance with the arrangement of a plurality of electrode terminals to which the inter-electrode-terminal connection component is to be attached.
(2) The first electrode connection portion and the second electrode connection portion that connect two adjacent electrode terminals need not have the same shape, and a combination of different shapes may be employed. For example, the second electrode connection portion of Embodiment 1 above may have the same shape as the shape of the second electrode connection portion of Embodiment 6 (Embodiment 3) above, and the right coupling portion of Embodiment 1 above may be overlaid on the coupling-target portion protruding upward from the connection portion, from the outer side (right side) in the left-right direction and fixed thereto.
(3) The shapes of the elastically deformable portions described in the embodiments above are exemplary and are not limitative. For example, in Embodiment 1 above, the shape of the elastically deformable portion 32 is constituted by a single “substantially gutter shape” formed by the pair of side wall portions 36 and the bottom wall portion 38, but, for example, the elastically deformable portion may have an uneven shape in which a plurality of gutter shapes are continuously arranged in the left-right direction at intervals. Similarly, in Embodiment 3 above, the shape of the elastically deformable portion 60 is constituted by a single “substantially arch shape” as a whole, but, for example, the elastically deformable portion may have a wave shape in which a plurality of arch shapes are continuously arranged in the left-right direction at intervals. In addition, the elastically deformable portion of the inter-electrode-terminal connection component of the present disclosure may include at least one bent portion as in Embodiments 1 to 4, but there is no limitation on the number of bent portions. For example, in Embodiment 1 above, the elastically deformable portion includes four bent portions 34 (the pair of first bent portions 34a and the pair of second bent portions 34b), but may include, for example, a pair of first bent portions and one second bent portion, and the elastically deformable portion of Embodiment 1 may have, for example, a substantially V shape open upward.
(4) The connection portions of the electrode connection portions need not extend horizontally, and may have a configuration in which, for example, one of the connection portions is located above the other when the electrode connection portions are connected to the electrode terminals. In this case, when the electrode connection portions are connected to the electrode terminals, the electrode connection portions may be brought into a state of extending in the horizontal direction through additional bending of the elastically deformable portion or the like and then connected to the electrode terminals. Thus, the deformation amount (bending amount) of the elastically deformable portion need not be strictly monitored during the production of the inter-electrode-terminal connection component, which leads to an improvement of the production efficiency of the inter-electrode-terminal connection component.
(5) The electrode terminals connected via the inter-electrode-terminal connection component of the present disclosure are not limited to the electrode terminals of the adjacent battery cells, and the inter-electrode-terminal connection component may connect the electrode terminals of different devices (e.g., a motor and an inverter) adjacent to each other.

### LIST OF REFERENCE NUMERALS

10 Inter-electrode-terminal connection component (Embodiment 1)
12 Electrode terminal
12a Positive electrode terminal
12b Negative electrode terminal
14 Battery cell
16 Electrode connection portion
16a First electrode connection portion
16b Second electrode connection portion
18 Intermediate conductive portion
20 Coupling-target portion
22 Connection portion
24 Vertical portion
26 Through hole
28 Metal thin plate
30 Coupling portion
32 Elastically deformable portion
34 Bent portion
34a First bent portion
34b Second bent portion
36 Side wall portion
38 Bottom wall portion
40 Inter-electrode-terminal connection component (Embodiment 2)
42 Electrode connection portion
42a First electrode connection portion
42b Second electrode connection portion
44 Intermediate conductive portion
46 Elastically deformable portion
48 Top wall portion
50 Inter-electrode-terminal connection component (Embodiment 3)
52 Electrode connection portion
52a First electrode connection portion
52b Second electrode connection portion
54 Intermediate conductive portion
56 Coupling-target portion
58 Coupling portion
60 Elastically deformable portion
62 Bent portion
70 Inter-electrode-terminal connection component (modified example of Embodiment 3)
72 Slit
80 Inter-electrode-terminal connection component (Embodiment 4)
90 Inter-electrode-terminal connection component (Embodiment 5)
92 Intermediate conductive portion
94 Elastically deformable portion
96 Coupling portion
100 Inter-electrode-terminal connection component (Embodiment 6)
102 Intermediate conductive portion
104 Elastically deformable portion
106 Coupling portion
110 Inter-electrode-terminal connection component (FIG. 10)

1. An inter-electrode-terminal connection component comprising:
a plurality of electrode connection portions that are configured to be respectively connected to a plurality of electrode terminals adjacent to one another; and
an intermediate conductive portion that is disposed between the electrode connection portions adjacent to each other and in which the electrode connection portions are coupled to two ends,
wherein the electrode connection portions are each constituted by a single flat metal plate, and
the intermediate conductive portion is constituted by a laminated busbar formed by stacking a plurality of metal thin plates that are thinner than the flat metal plate, and includes an elastically deformable portion that is elastically deformed and thus accepts displacement of the electrode connection portions approaching each other or separating from each other.

2. The inter-electrode-terminal connection component according to claim 1,
wherein the intermediate conductive portion includes plate-shaped coupling portions at the two ends and the elastically deformable portion is constituted by a portion between the coupling portions, and
the electrode connection portions each include a plate-shaped coupling-target portion that is overlaid on and coupled to the coupling portion of the intermediate conductive portion, and a plate-shaped connection portion that is configured to be overlaid on and connected to the electrode terminal.

3. The inter-electrode-terminal connection component according to claim 2,
wherein the coupling-target portions of the electrode connection portions each protrude toward an upper side that is farther from the electrode terminal than the connection portion is.

4. The inter-electrode-terminal connection component according to claim 2,
wherein, in each of the electrode connection portions, a side edge portion located near the electrode connection portion coupled via the intermediate conductive portion is bent toward an upper side that is farther from the electrode terminal than the connection portion is, and forms the coupling-target portion protruding toward the upper side with respect to the connection portion, and
the coupling portions of the intermediate conductive portion are each overlaid on the coupling-target portion in a direction in which the electrode connection portion adjacent to each other approach each other or separate from each other, and coupled thereto.

5. The inter-electrode-terminal connection component according to claim 2,
wherein, in each of the electrode connection portions, a side edge portion located near the electrode connection portion coupled via the intermediate conductive portion is bent toward an upper side that is away from the electrode terminal, is further bent toward the electrode connection portion coupled via the intermediate conductive portion, and forms the coupling-target portion that is located on the upper side with respect to the connection portion and extends parallel to the connection portion, and
the coupling portions of the intermediate conductive portion are each overlaid on the coupling-target portion from the upper side and coupled thereto.

6. The inter-electrode-terminal connection component according to claim 1,
wherein the elastically deformable portion of the intermediate conductive portion includes at least one bent portion formed by bending the intermediate conductive portion in a thickness direction.

7. The inter-electrode-terminal connection component according to claim 6,
wherein the elastically deformable portion of the intermediate conductive portion includes a plurality of bent portions that are disposed at an interval in a direction in which the electrode connection portions approach each other or separate from each other and has an arch shape curved toward one side in the thickness direction as a whole.

8. The inter-electrode-terminal connection component according to claim 6,
wherein the intermediate conductive portion includes plate-shaped coupling portions at the two ends and the elastically deformable portion is constituted by a portion between the coupling portions, and
the elastically deformable portion of the intermediate conductive portion includes four bent portions, the four bent portions includes a pair of first bent portions that are bent toward one side in the thickness direction near the coupling portions, and a pair of second bent portions that are disposed between the pair of first bent portions and are bent toward the other side in the thickness direction, and the elastically deformable portion has a gutter shape as a whole.

9. The inter-electrode-terminal connection component according to claim 1,
wherein the elastically deformable portion of the intermediate conductive portion protrudes toward an upper side that is farther from the electrode terminals than the electrode connection portions are.

10. The inter-electrode-terminal connection component according to claim 5,
wherein the elastically deformable portion of the intermediate conductive portion is disposed on the upper side with respect to the connection portions of the electrode connection portions and protrudes downward of the coupling-target portions of the electrode connection portions.
